(19) United States
(12) Patent Application Publication
(10) Pub. No.: US 2013/0068309 A1
(43) Pub. Date: Mar. 21, 2013

(54) POSITION CONTROLLER FOR PILOT-OPERATED ELECTROHYDRAULIC VALVES

(71) Applicant: Robb Gary Anderson, Eden Prairie, MN (US)

(72) Inventor: Robb Gary Anderson, Eden Prairie, MN (US)

(21) Appl. No.: 13/614,116

(22) Filed: Sep. 13, 2012

Related U.S. Application Data
(60) Provisional application No. 61/535,097, filed on Sep. 15, 2011.

(51) Int. Cl. F17D 3/00

(52) U.S. Cl. 137/1

(57) ABSTRACT

A flow control valve includes a housing that includes a fluid inlet, a fluid outlet, a first work port and a second work port. The housing defines a spool bore and a pilot spool bore. A main stage spool is disposed in the spool bore. A pilot stage spool is disposed in the pilot spool bore. The pilot stage spool is in selective fluid communication with the main stage spool. A microprocessor includes a controller having a position controller module, a velocity transform module, and a dynamic offset module. The controller is configured to implement a training process, and to compensate for viscosity changes in the working fluid based on data obtained during the training process. Outputs of the controller are communicated to the pilot stage spool.

### CROSS-REFERENCE TO RELATED APPLICATIONS

The present application claims the benefit of U.S. Provisional Patent Application Ser. No. 61/535,097, filed Sep. 15, 2011, and entitled “Position Controller for Pilot-Operated Electrohydraulic Valves”, which application is hereby incorporated by reference in its entirety.

### TECHNICAL FIELD

This disclosure relates to control systems and methods for use in electro-hydraulic valve applications.

### BACKGROUND

Electro-hydraulic valves are used in many industrial and mobile applications. Often times, an electro-hydraulic valve will need to be tuned or trained by the system controller such that it can be used in the system. Such training can involve a time consuming iterative process that substantially extends manufacturing and equipment down time. The operation of the electro-hydraulic valve is also affected by viscosity changes in the working fluid, sometimes inadequately accounted for by the control system.

### SUMMARY

The present disclosure is directed to systems and methods for operating a hydraulic valve assembly having at least one main stage spool actuated by hydraulic fluid from a pilot stage spool, wherein the pilot stage spool is actuated by a coil receiving a command PWM output voltage from a controller.

In one aspect, the assembly can be configured for operation, or trained, by sensing a training temperature of the hydraulic fluid; correlating a plurality of pilot stage spool coil PWM output voltages to a plurality of resulting main stage spool velocities at the training temperature; determining a minimum PWM output voltage to cause the main stage spool to start moving in at least one direction; and by then storing the training temperature, the minimum PWM output voltage, and the correlated values as control parameters in the controller.

In one aspect, the method includes receiving and transforming a main stage spool position command to a velocity command with a structured control, such as a delayed proportional-integral-derivative (PID) control with a feed forward loop, and measuring an operating hydraulic fluid temperature. In one aspect, the method includes transforming the velocity command to an initial PWM output voltage, including the steps of: determining a viscosity difference, such as a kinematic or dynamic viscosity difference, between the hydraulic fluid at the training temperature and the hydraulic fluid at the operating temperature; temperature compensating the velocity command to account for the viscosity difference; and by referencing the control parameters to determine the initial PWM output voltage.

In one aspect, the method includes transforming the initial PWM output voltage to a command PWM output voltage by adding a PWM voltage offset value to the initial PWM output, the offset value being dependent upon at least some of the control parameters and sending the command PWM output voltage to the pilot stage spool coil.

A method of training a valve control assembly is also disclosed including the steps of sensing and recording a training fluid temperature; setting a maximum loop index value; initializing a loop index to an initial value; outputting a predetermined output PWM voltage to the pilot stage spool coil; optionally capturing the travel time of the main stage spool over a predetermined distance; calculating the characteristic velocity of the main stage spool, for example the average velocity; storing the average spool velocity corresponding to the output PWM voltage; returning the main stage spool to a null position; incrementing the loop index; and repeating the steps until loop index is equal to the maximum loop index value.

The above described methods may be implemented utilizing a controller having a position controller module; a velocity transform module; and a dynamic offset module, described further below.

This Summary is provided to introduce a selection of concepts, in a simplified form, that are further described below in the Detailed Description. This Summary is not intended to be used in any way to limit the scope of the claimed subject matter. Rather, the claimed subject matter is defined by the language set forth in the Claims of the present disclosure.

### BRIEF DESCRIPTION OF THE DRAWINGS

Aspects of the present disclosure may be more completely understood in consideration of the following detailed description of various embodiments in connection with the accompanying drawings.

FIG. 1 is a schematic representation of a hydraulic system having features that are examples of aspects in accordance with the principles of the present disclosure.

FIG. 2 is a schematic representation of a flow control valve assembly suitable for use in the hydraulic system of FIG. 1.

FIG. 3 is a process schematic for operating the hydraulic system of FIG. 1.

FIG. 4 is a process schematic for training a controller suitable for use in the hydraulic system of FIG. 1.

FIG. 5 is a process schematic adding further detail to steps shown in the schematic of FIG. 4.

FIG. 6 is a process schematic adding further detail to steps shown in the schematic of FIG. 4.

FIG. 7 is a process schematic adding further detail to steps shown in the schematic of FIG. 4.

FIG. 8 is a process schematic adding further detail to steps shown in the schematics of FIGS. 4-6.

FIG. 9 is a process schematic adding further detail to steps shown in the schematic of FIGS. 4 and 7.

FIG. 10 is a process schematic adding further detail to steps shown in the schematic of FIGS. 4 and 7.

FIG. 11 is a graph showing example results from the training process shown in FIG. 4-7.

FIG. 12 is an enlarged view of the graph of FIG. 11.

FIG. 13 is a schematic of a controller suitable for use in the flow control valve assembly of FIG. 2.

FIG. 14 is a process schematic for a position controller module suitable for use in the controller of FIG. 13.

FIG. 15 is a process schematic for a velocity transform module suitable for use in the controller of FIG. 13.

FIG. 16 is a process schematic for a first portion of a dynamic offset module suitable for use in the controller of FIG. 13.

FIG. 17 is a process schematic for a second portion of a dynamic offset module suitable for use in the controller of FIG. 13.

FIG. 18 is an exemplary schematic of the controller of FIG. 13.

FIG. 19 is an exemplary schematic of the velocity transform module of FIG. 13.

FIG. 20 is an exemplary schematic of the dynamic offset module of FIGS. 13 and 16-17.

FIG. 21 is an exemplary data array schematic suitable for use with the training method of FIGS. 4-12.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

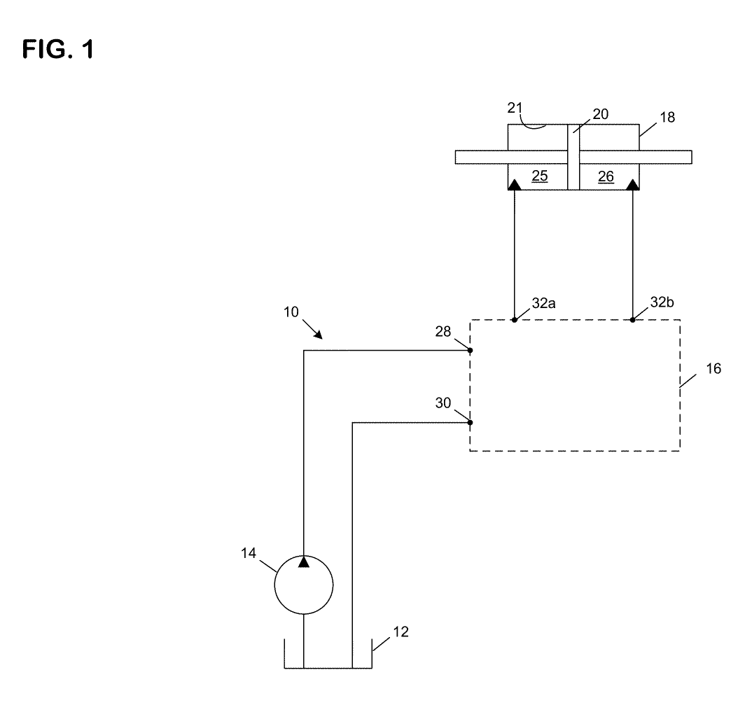

Referring now to FIG. 1, a schematic representation of a hydraulic system, generally designated 10 is shown. A similar system is disclosed in U.S. Patent Application Publication 2009/0312852 A1 entitled Auto-Tuning Electro-Hydraulic Valve, the entirety of which is hereby incorporated by reference into this application. In the subject embodiment, the hydraulic system 10 includes a reservoir 12, a fluid pump 14, shown herein as a fixed displacement pump, a first device, generally designated 16, and a second device, generally designated 18. In one aspect of the present disclosure, the first device 16 is a flow control valve assembly while the second device 18 is an actuator, shown herein as a linear actuator or cylinder.

In the subject embodiment, the actuator 18 includes a piston 20, which separates an internal bore 21 of the actuator 18 into a first chamber 25 and a second chamber 26. While the actuator 18 is described in the present disclosure as a linear actuator, it will be understood, that the actuator 18 of the hydraulic system 10 is not limited to being a linear actuator as the actuator 18 could alternative be a rotary actuator (e.g., a motor, etc.).

In the subject embodiment, the flow control valve assembly 16 is an electro-hydraulic control valve. The flow control valve assembly 16 includes a plurality of ports including a supply port 28 that is adapted for fluid communication with the fluid pump 14, a tank port 30 that is adapted for fluid communication with the reservoir 12, a first work port 32a and a second work port 32b. The first work port 32a is in fluid communication with the first chamber 25 of the actuator 18 while the second work port 32b is in fluid communication with the second chamber 26 of the actuator 18.

In the subject embodiment, when the flow control valve assembly 16 allows fluid communication between the supply port 28 and the first work port 32a and between the tank port 30 and the second work port 32b, pressurized fluid from the fluid pump 14 flows through the flow control valve assembly 16 into the first chamber 25 of the actuator 18 while fluid from the second chamber 26 of the actuator 18 flows to the reservoir 12. This fluid communication results in the extension of the actuator 18. In the alternative, when the flow control valve assembly 16 allows fluid communication between the tank port 30 and the first work port 32a and between the supply port 28 and the second work port 32b, pressurized fluid from the fluid pump 14 flows through the flow control valve assembly 16 into the second chamber 26 of the actuator 18 while fluid from the first chamber 25flows to the reservoir 12. This fluid communication results in the retraction of the actuator 18.

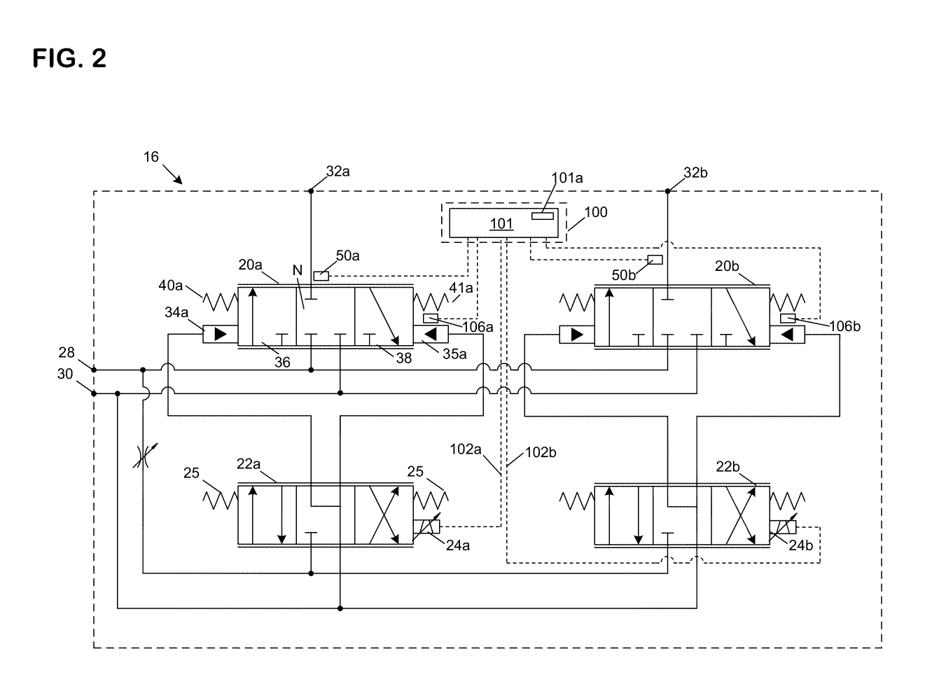

Referring now to FIG. 2, a schematic representation of an exemplary embodiment of the flow control valve assembly 16 is shown. In the depicted embodiment of FIG. 2, the flow control valve assembly 16 is arranged as a twin spool two-stage valve. It will be understood, however, that the scope of the present disclosure is not limited to the flow control valve assembly 16 being a twin spool two-stage valve.

The flow control valve assembly 16 includes a first main stage spool 20a, which is in fluid communication with a first pilot stage spool 22a, and a second main stage spool 20b, which is in fluid communication with a second pilot stage spool 22b. The position of the first and second pilot stage spools 22a, 22b are controlled by electromagnetic actuators 24a, 24b, respectively. In the subject embodiment, the electromagnetic actuators 24a, 24b are voice coils.

As the first and second main stage spools 20a, 20b are substantially similar in the subject embodiment, the first and second main stage spools 20a, 20b will be collectively referred to as main stage spools 20 in either the singular or plural form as required by context. Similarly, the first and second pilot stage spools 22a, 22b and the first and second electromagnetic actuators 24a, 24b will be collectively referred to as pilot stage spools 22 and electromagnetic actuators 24, respectively, in either the singular or plural form as required by context. It will be understood, however, that the scope of the present disclosure is not limited to the first and second main stage spools 20a, 20b, the first and second pilot stage spools 22a, 22b and the first and second electromagnetic actuators 24a, 24b being substantially similar.

The main stage spools 20 are pilot actuated. When pressurized fluid is supplied to a first end 34 of the main stage spool 20, the main stage spool 20 is actuated to a first position 36. When pressurized fluid is supplied to an opposite second end 35 of the main stage spool 20, the main stage spool 20 is actuated to a second position 38. In the first position 36, fluid is communicated from the supply port 28 to the work port 32. In the second position 38, fluid is communicated from the work port 32 to the tank port 30. In the subject embodiment, the main stage spool 20 is biased to a neutral position N by springs 40a and 41a disposed on each of the ends 34 and 35 of the main stage spool 20.

The positions of the pilot stage spools 22 control the positions of the main stage spools 20 by regulating the fluid pressure that acts on the ends 34 and 35 of the main stage spools 20. In addition to controlling whether the work port 32 is in fluid communication with the supply port 28 or the tank port 30, the positions of the main stage spools 20 control the flow rate of fluid to the work port 32. The pilot stage spools 22 are actuated in response to electrical signals received by the electromagnetic actuators 24. The pilot stage spools 22 are held in a neutral position by springs 25 when no power is sent to the actuators 24. A single spring 25 may also be utilized. In the subject embodiment, the electrical signals received by the electromagnetic actuators 24 are pulse width modulation (PWM) voltage signals. The pulse width modulation signals are square waves whose pulse width can be modulated in order to vary the value (i.e., the PWM value) of the waveform, sometimes referred to as a duty cycle. By varying the PWM value, the pilot stage spools 22 can be more accurately positioned and controlled. In other examples, the current can be monitored and/or controlled. In such an example, instead of PWM, a current command could be used based on closed-loop current. The PWM output voltage command and the current command, both of which control force on the coil, can be referred to as a voice coil command or reference.

The flow control valve assembly 16 further includes a microprocessor 100. The microprocessor 100 includes a controller 101 having at least one storage medium 101a, such as an EEPROM. In this embodiment, instructions are encoded on the storage medium 101a that can be executed by the microprocessor 100. For example, the microprocessor 100 can execute instructions stored on the storage medium 101a to implement one or more of the method steps described herein.

In the subject embodiment, the controller 100 selectively provides command signals 102a, 102b to the pilot stage spools 22. In one aspect of the present disclosure, the command signals 102a, 102b are electrical signals. In another aspect of the present disclosure, the electrical signals 102a, 102b are PWM signals. In response to the PWM signals 102a, 102b, the pilot stage spools 22 are actuated such that pressurized fluid is communicated to one of the ends 34 of each of the main stage spools 20. As the first and second signals 102a, 102b are substantially similar in the subject embodiment, the first and second signals 102a, 102b will be collectively referred to as signals 102 in either the singular or plural form as required by context.

In the subject embodiment, the controller 100 provides the PWM signals 102 in response to information received from the hydraulic system 10 and/or from an operator of the hydraulic system 10. The controller 100 receives information regarding a desired system parameter that corresponds to a desired system output (e.g., position of the actuator 18, flow to the actuator 18, etc.) and information regarding an actual system parameter. The corresponding desired system output (or set point) can be inputted by an operator in a variety of ways, including but not limited to a joystick used by the operator or through a keyboard. The actual system parameter can be received from any of the sensors in the flow control valve assembly 16 or from any sensors in the hydraulic system 10.

For example in one embodiment, the controller 100 receives information from first and second spool position sensors 106a, 106b regarding the positions of the first and second main stage spools 20a, 20b, respectively. In this embodiment, the first and second position sensors 106a, 106b can be, but are not limited to, Linear Variable Differential Transformers (LVDTs). In this embodiment, the controller 100 would be characterized as a spool position controller. In another embodiment, the controller 100 receives information from first and second pressure sensors 50a, 50b. In this embodiment, the pressure sensors 50a, 50b are disposed in the work ports 32. In this embodiment, the controller 100 would be characterized as a pressure controller. In another embodiment, the controller 100 could be a spool position and pressure controller. Additionally, flow control can be utilized either independently or in conjunction with position and pressure control.

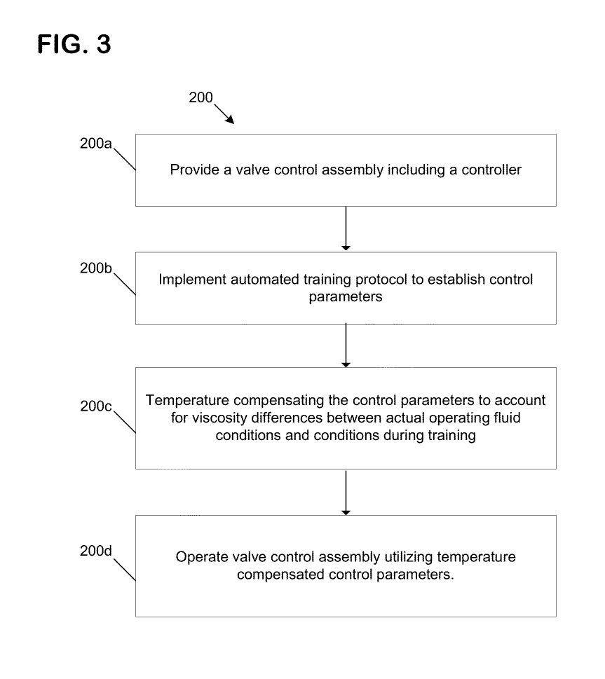

As shown in FIG. 3, a method 200 is disclosed in which a flow control assembly, such as assembly 16, can be provided to a hydraulic system (step 200a), such as hydraulic system 10, and subjected to an automated training protocol step 200b. The training step can be implemented either before flow control assembly is actually placed into a hydraulic system 10. The automated training protocol step is necessary because control parameters of the controller 100 are affected by a number of factors, including but not limited to manufacturing tolerances of the flow control valve assembly 16, assembly variation of the flow control valve assembly 16, and loading conditions on the flow control valve assembly 16. As a result, the control parameters need to be tuned or adjusted to optimum values in order to achieve a desired control response. If the control parameters are incorrectly chosen, however, the flow control valve assembly 16 can become unstable.

Once training is complete, the control parameters are temperature compensated in step 202c to account for viscosity differences between the actual operating fluid conditions and the conditions that were present during training An operating step 202d can be implemented in which control parameters identified during training are utilized by the controller 100 in a temperature and viscosity compensated form.

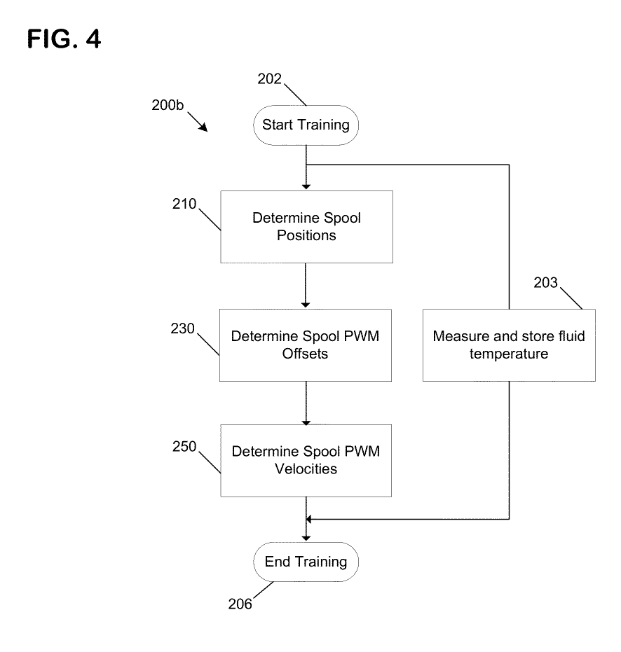

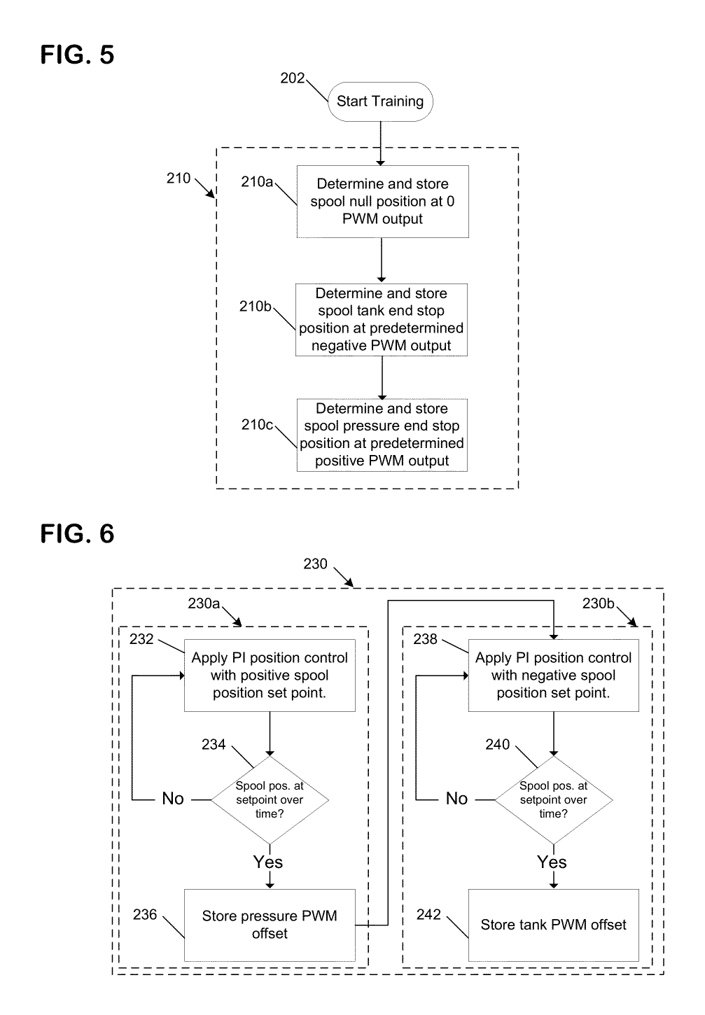

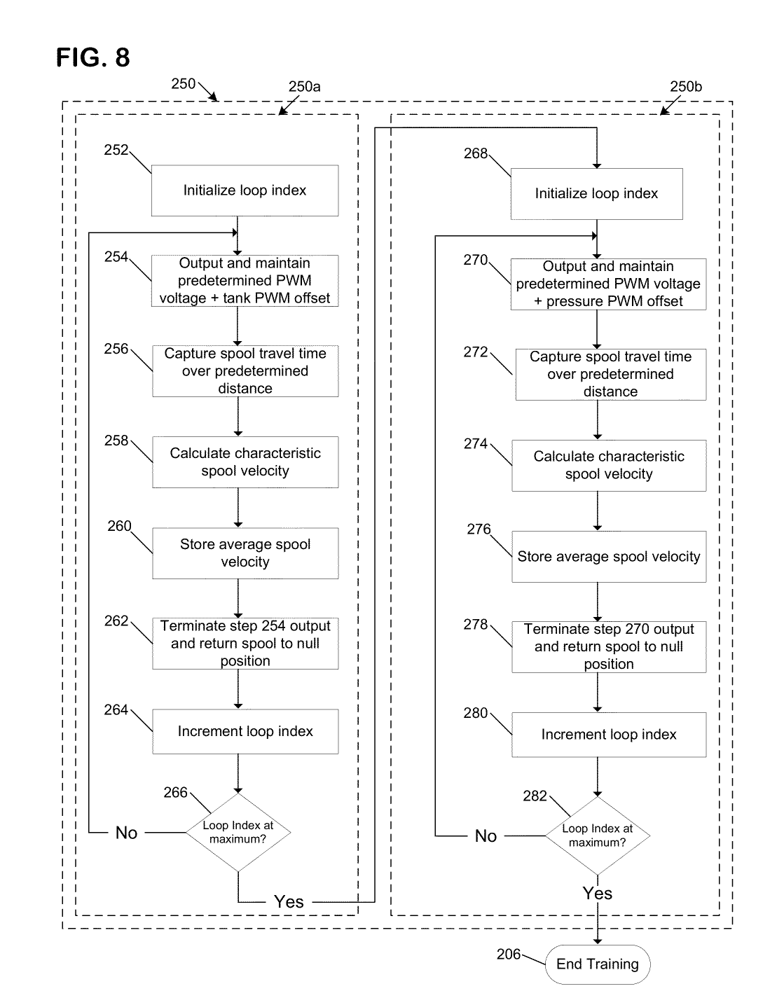

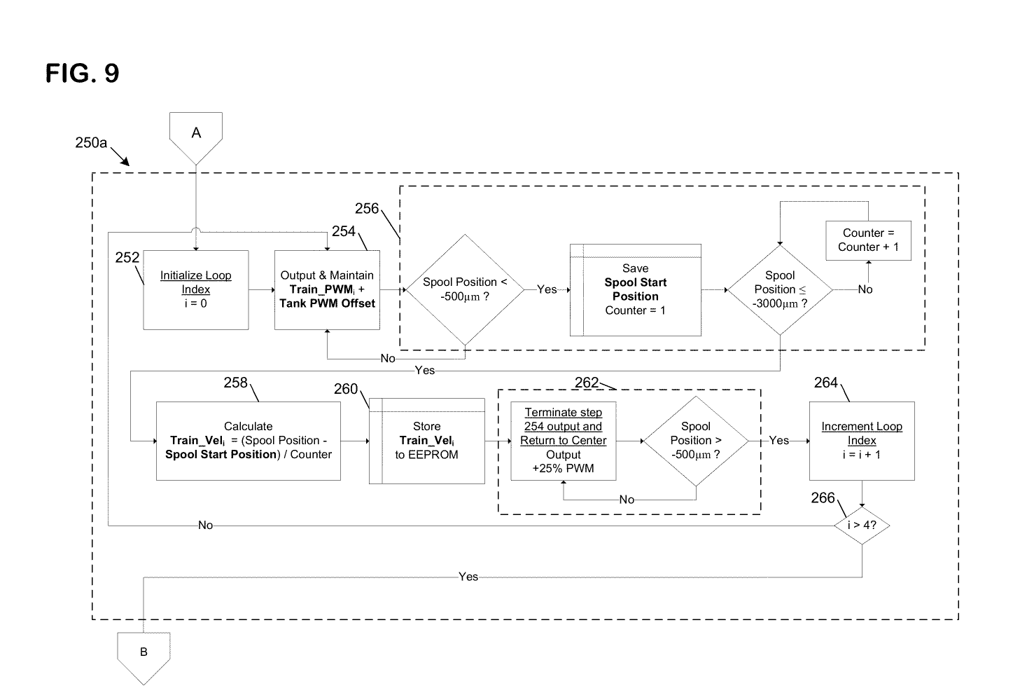

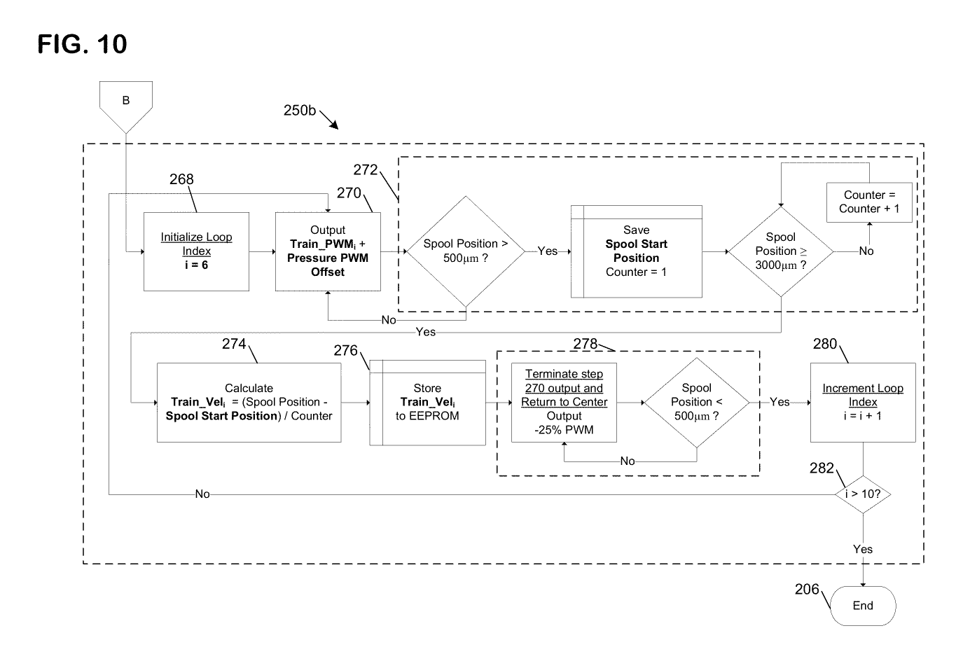

With reference to FIGS. 4-10, the automated training protocol step 200b is further described. In the most general terms, the training protocol step 200b is initiated at step 202 and can include a spool position determination step 210, a spool PWM offset determination step 230, and a spool PWM velocity determination step 250. At any point during the training protocol step 200b, the temperature of the fluid is measured and stored at step 203. Alternatively, the temperature can be monitored continuously throughout step 200b and stored as an average or median value in step 203. The training protocol is completed at a termination step 206.

During the spool position determination step 210, as shown in FIGS. 4, 5, and 8, the sensors of the flow control valve assembly 16 provide readings to the microprocessor 101 in a null position determination step 210a, tank end stop position determination step 210b, and a pressure end stop position determination step 210c. These measured positions define the full range of operation of the valve spool 20. To determine the null position, an output of 0 PWM is sent to the valve actuator 24, and a timer is allowed to expire, as shown in steps 212, 214. As no voltage is applied to the valve actuator, valve spool 20 will remain centered in the null position. This position is then stored in the storage medium 101a in step 216, such as an EEPROM, of the controller 100.

To determine the tank end stop position, a negative output voltage, for example −25% of maximum PWM, is sent to the valve actuator 24, and a timer is allowed to expire, as shown in steps 218, 220. The tank end stop position correlates to the fullest extent the valve spool 20 moves to the tank side position. The timer duration is set to ensure that the valve spool 20 fully moves to the tank end stop position. This position is then stored in the storage medium 101a, such as an EEPROM, of the controller 100 in step 222.

To determine the pressure end stop position, a positive output voltage, for example +25% of maximum PWM, is sent to the valve actuator 24, and a timer is allowed to expire, as shown in steps 224, 226. The timer duration is set to ensure that the valve spool 20 fully moves to the pressure end stop position. The pressure end stop position correlates to the fullest extent the valve spool 20 moves to the pressure side position. This position is then stored in the storage medium 101a, such as an EEPROM, of the controller 100 in step 228. Once these three positions have been determined and stored, the spool position determination step 210 is complete.

During the spool PWM offset determination step 230, as shown in FIGS. 4, 6, and 8, the sensors of the flow control valve assembly 16 provide readings to the microprocessor 101 in a pressure PWM offset determination step 230a and a tank PWM offset determination step 230b. These offset determinations allow the controller to identify the minimum voltage required to move the valve spool 20 in either direction. In the pressure PWM offset determination step 230a, a closed loop proportional-integral position control 232 is utilized wherein a null spool position is used as a set point plus a small distance, for example, +50 micrometers (μm).

The spool position is then observed in a step 234 over various PWM outputs by the microprocessor 100 until the position is within a predetermined tolerance, for example +/−10 μm, from the set point for a predetermined time period, for example 150 milliseconds (ms). Steps 232 and 234 are repeated until this desired condition is attained. Once the spool position has attained this position, a corresponding pressure PWM offset voltage is stored in the storage medium 101a, such as an EEPROM, in step 236. As shown, the tank PWM offset determination step 230b, is similar to step 230a, with the exception that a negative position is utilized with respect to the position set point, for example, −50 μm in a step 238. Once the spool position has attained this position for a predetermined time period in a step 240, a corresponding tank PWM offset voltage is stored in the storage medium 101a, such as an EEPROM, in step 242.

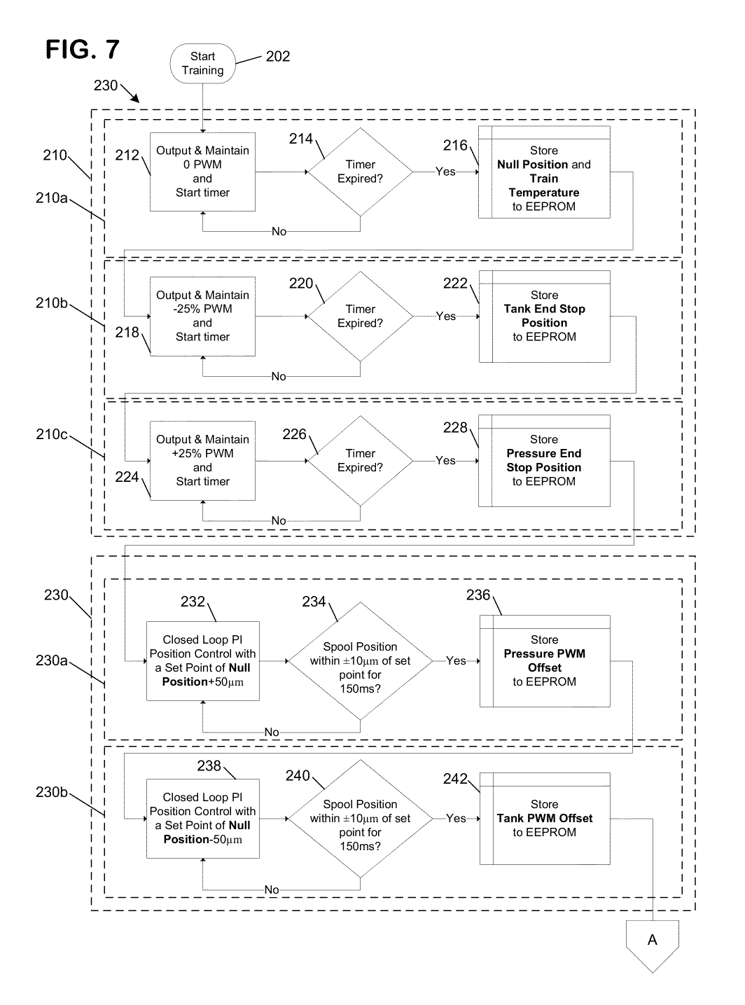

During the spool PWM velocity determination step 250 an array is created that correlates output PWM voltages to the characteristic travel velocity of the valve spool 20. This is done for the valve spool 20 moving in the tank direction in a step 250a (FIG. 6, 9) and moving in the pressure direction in a step 250b (FIG. 7, 10).

In general, the control loop in step 250a will index through a series of predetermined PWM output values ranging from the most negative PWM voltage that would be applied during use to the least negative PWM voltage that would be applied during use. The applied PWM voltage output, applied in step 254, includes the offset value found in the PWM offset determination step 230a. As shown, the loop is initially indexed to a value of zero in initialization step 252. At each discrete PWM output value for each index step, the valve spool 20 is monitored as it travels from a neutral position through a starting and ending position in a monitoring step 256. When the valve spool 20 reaches the starting position, a counter will start which is stopped once the valve spool reaches the ending position.

In one embodiment, the starting and ending position are −500 μm and −3,000 μm from the null position, respectively. In the embodiment shown, the counts are added to the counter every 1.5 ms. Once the spool 20 has reached the ending position, the characteristic velocity for the spool 20 can be calculated by subtracting the starting position from the ending position and dividing the result by the time value correlating to the number of counts required to travel this distance, as shown in calculation step 258. Alternatively, the calculated characteristic velocity can be the maximum spool velocity, the median spool velocity, or the entire velocity profile over the travel distance. In the embodiment shown, this value is stored as Train_Velᵢ in the storage medium 101a, such as an EEPROM, in storage step 260. The spool 20 is then returned to the null position in repositioning step 262 by terminating the step 254 PWM output voltage and optionally applying a reverse voltage of +25% PWM output until the spool extends beyond the starting position. The loop is then incrementally indexed upward in step 264. Steps 254 to 264 are repeated until the desired number of data points has been achieved via the loop index maximum set at 266. In the embodiment shown, this loop is repeated until a total of five readings have been taken (increment loop index values from 0 to 4).

Once step 250a is completed, a similar process step 250b is applied for the valve spool 20 moving in the pressure direction, as shown in FIG. 7. In step 250b, the control loop will index through a series of PWM output values ranging from the least positive PWM voltage that would be applied during use to the most positive PWM voltage that would be applied during use. The applied PWM voltage output, applied at step 270, includes the offset value found in the PWM offset determination step 230b.

As shown, the loop is initially indexed to a value of six in initialization step 268. At each discrete PWM output value for each index step, the valve spool 20 is monitored as it travels from a neutral position through a starting and ending position in monitoring step 272. When the valve spool 20 reaches the starting position a counter will start which is stopped once the valve spool reaches the ending position. In one embodiment, the starting and ending positions are +500 μm and +3,000 μm from the null position, respectively. In the embodiment shown, the counts are added to the counter every 1.5 ms.

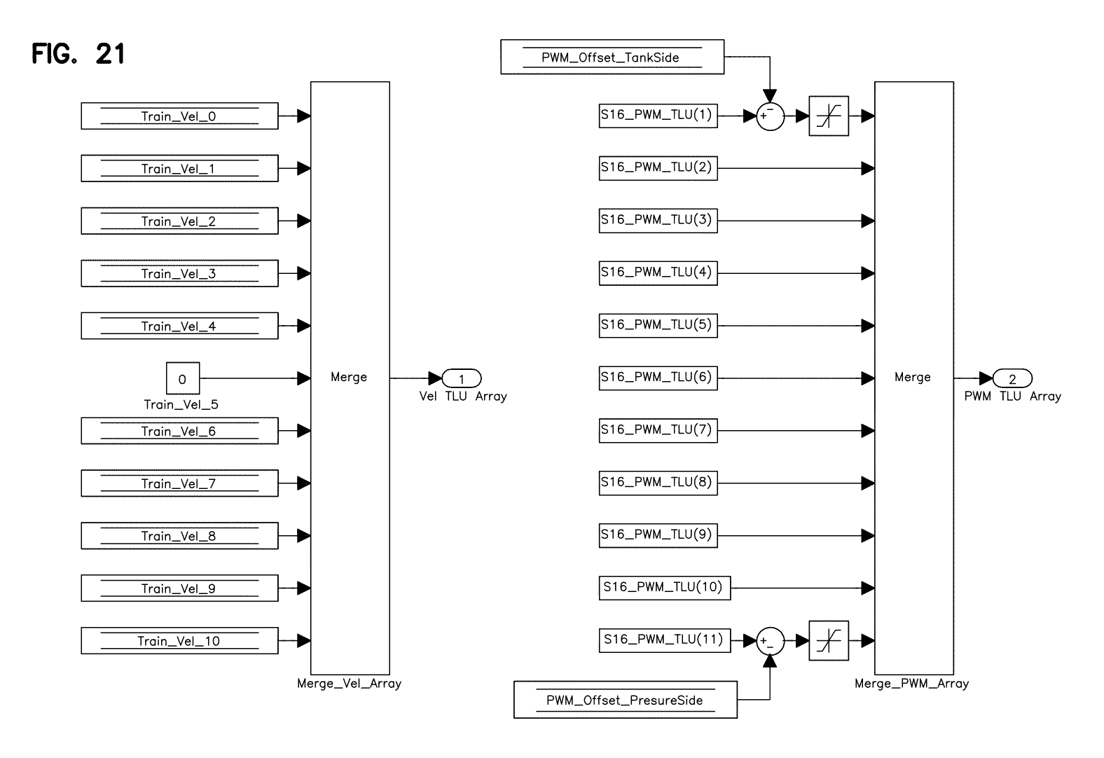

Once the spool 20 has reached the ending position, the average velocity for the spool 20 can be calculated by subtracting the starting position from the ending position and dividing the result by the time value correlating to the number of counts required to travel this distance, as shown in calculation step 274. Alternatively, the calculated characteristic velocity in step 274 can be the maximum spool velocity, the median spool velocity, or the entire velocity profile over the travel distance. In the embodiment shown, this value is stored as Train_Velᵢ in the storage medium 101a, such as an EEPROM, in storage step 276. The spool 20 is then returned to the null position in repositioning step 278 by terminating the step 270 PWM output voltage and optionally applying a reverse voltage of −25% PWM output until the spool moves beyond the starting position. The loop is then incrementally indexed upward in indexing step 280. Steps 270 to 280 are repeated until the desired number of data points has been achieved via the loop index maximum set point at 282. In the embodiment shown, this loop is repeated until a total of five readings have been taken (increment loop index values from 6 to 10). FIG. 21 shows further detail on how the training data can be stored, implemented, and merged for real-time use.

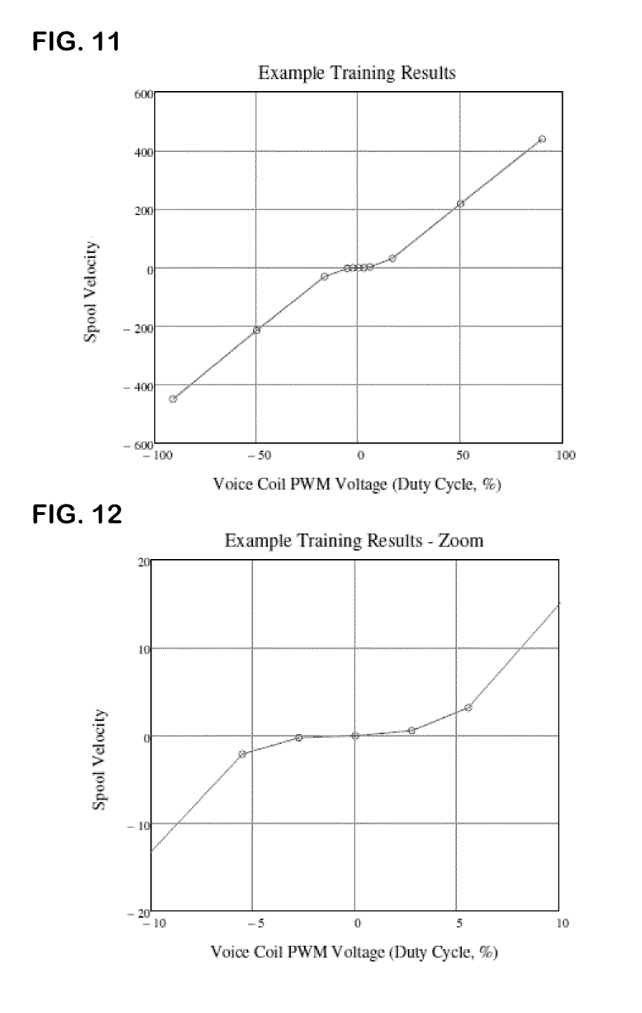

Once the loop is terminated at step 206, the training protocol step 200b is complete. It is noted that the stored array carries a median velocity value of zero corresponding to a zero PWM voltage at index point 5. One skilled in the art will appreciate that the PWM velocity determination step 250 does not require time consuming reiteration steps and is therefore able to be completed in a simpler and faster manner, as compared to some prior art systems. Example results from the training are shown at FIG. 11, a portion of which is shown further enlarged on FIG. 12. As can be easily seen in these figures, it is noted that the spool velocity does not have a linear response for all applied voltages, especially near null voltage.

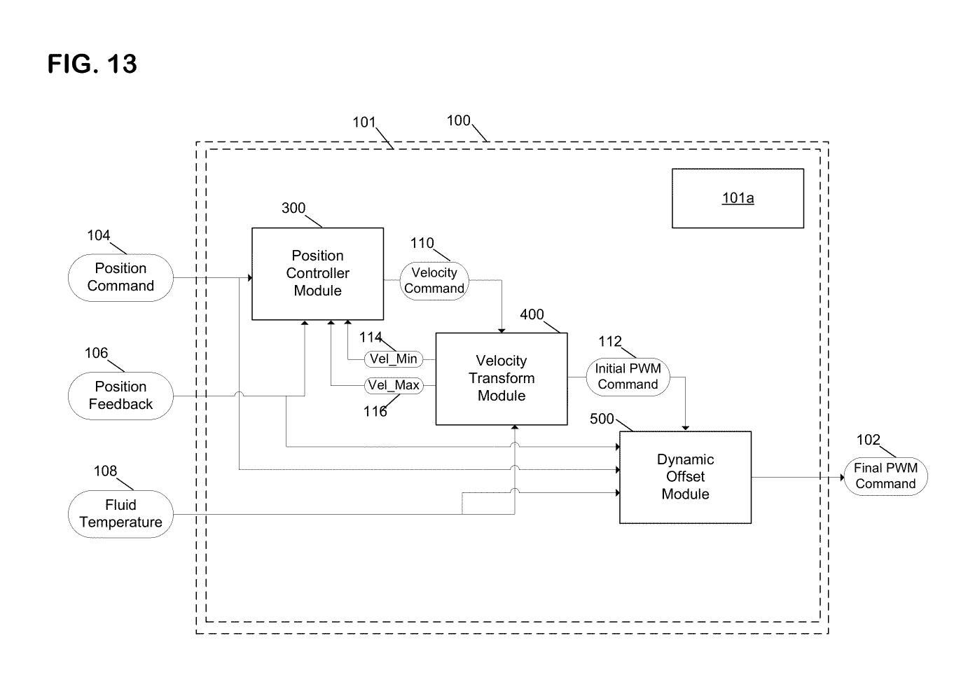

Referring now to FIG. 13, microprocessor 100 and controller 101 are shown in greater detail in schematic form. The controller 100 is adapted to generate the final PWM signal 102 such that the final PWM signal 102 corresponds to a desired performance characteristic of the flow control valve assembly 16. For example, if an operator or manufacturer believes that responsiveness of the flow control valve assembly 16 is more important than accuracy, control parameters of the controller 100 can be optimized to achieve that result. If, however, accuracy is more important, the control parameters of the controller 100 can be optimized to minimize the error between the actual system parameter (e.g., actual main stage spool position, etc.) as measured by the sensors and the desired system parameter (e.g., desired main stage spool position, etc.).

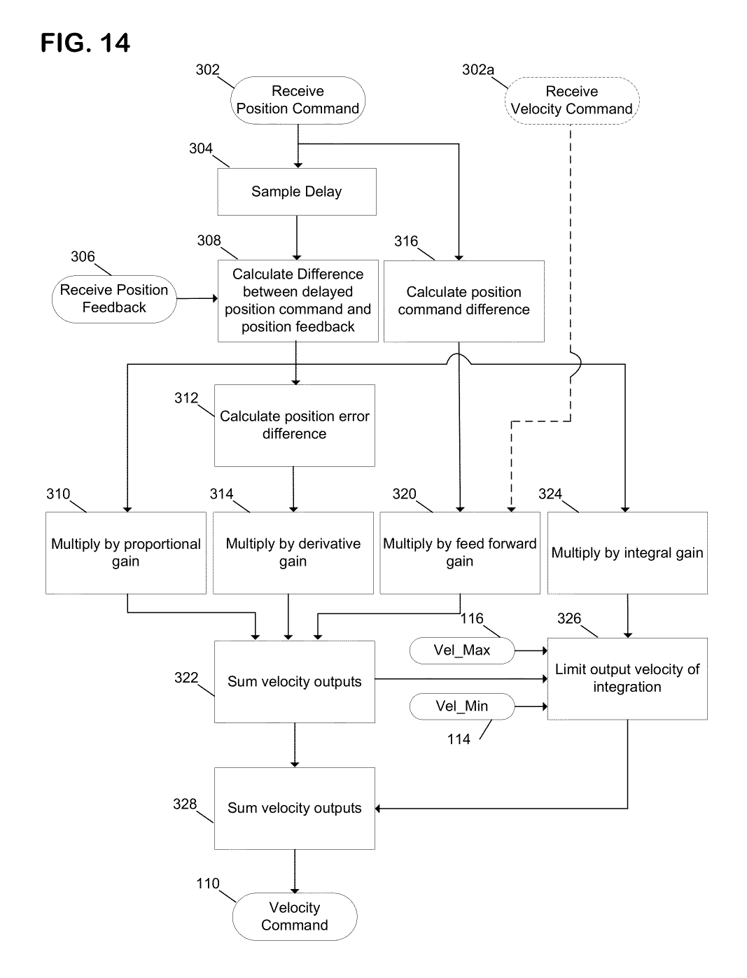

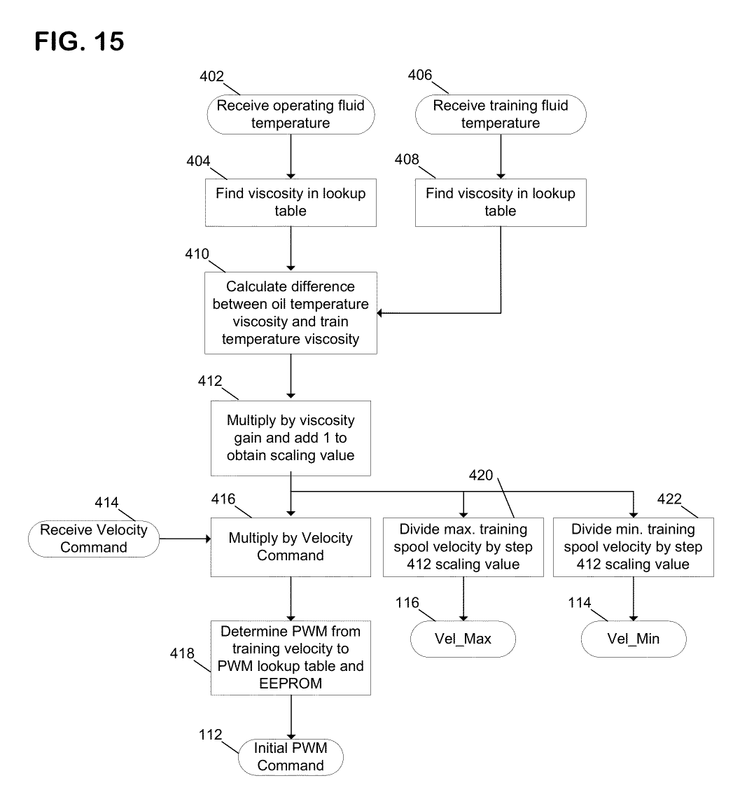

In one embodiment, controller 101 includes a position controller module 300, a velocity transform module 400, and a dynamic offset module 500. In general terms, the position controller module 300 is for determining a velocity command 110 from an initial position command 104 utilizing a structured control to transform the position signal into a velocity signal. In the embodiment shown, the structured control has state feedback (PID), delay, and feedforward (velocity) aspects. However, one skilled in the art will recognize that the structured control may include any number or combination of feedback values (proportional, integral, derivative), feed forward values, and/or system delay values in order to satisfy specific system requirements. A simple structured control would be a closed loop proportional control. The velocity command 110 is received by the velocity transform module 400 which performs a temperature compensation function to account for viscosity differences in the actual operating fluid as compared to the fluid conditions during the training protocol. The velocity transform module 400 outputs an initial PWM voltage output command, based on the training parameters, is received by the dynamic offset module 500. The dynamic offset module 500 modifies the initial PWM command by taking into account, among other things, the valve spool 20 position and the PWM offsets in order to calculate a final PWM command that is sent to the voice coils 24. The process steps used for each of the position controller module 300, the velocity transform module 400, and the dynamic offset module 500 are shown in FIGS. 14-17

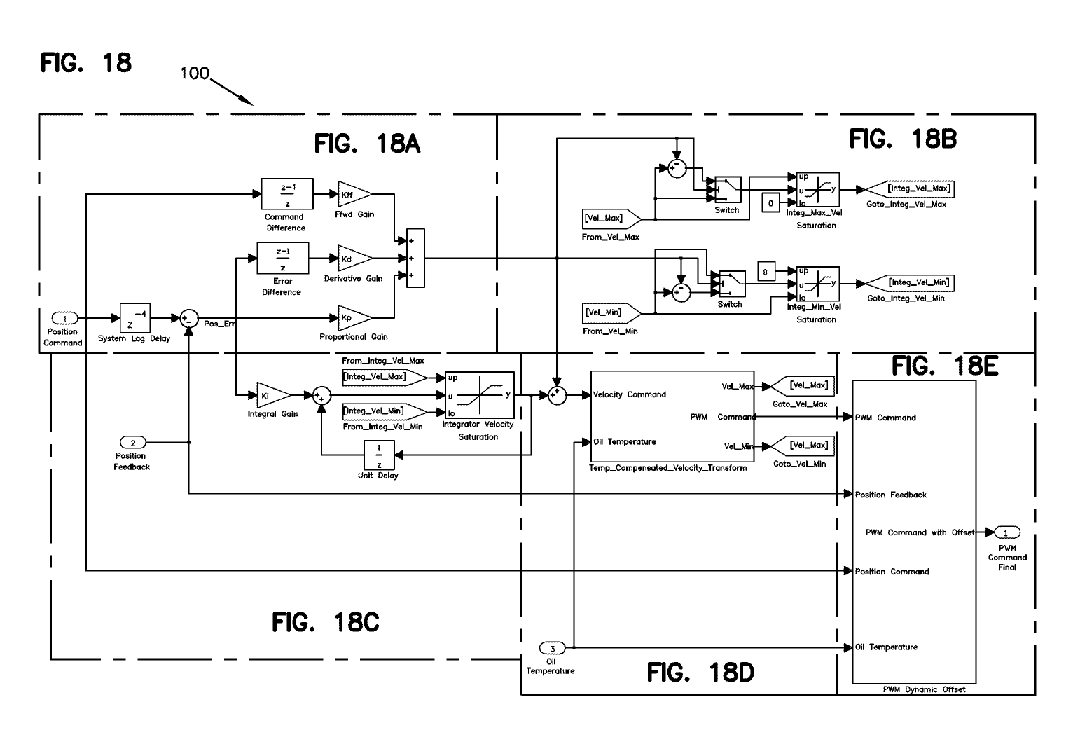

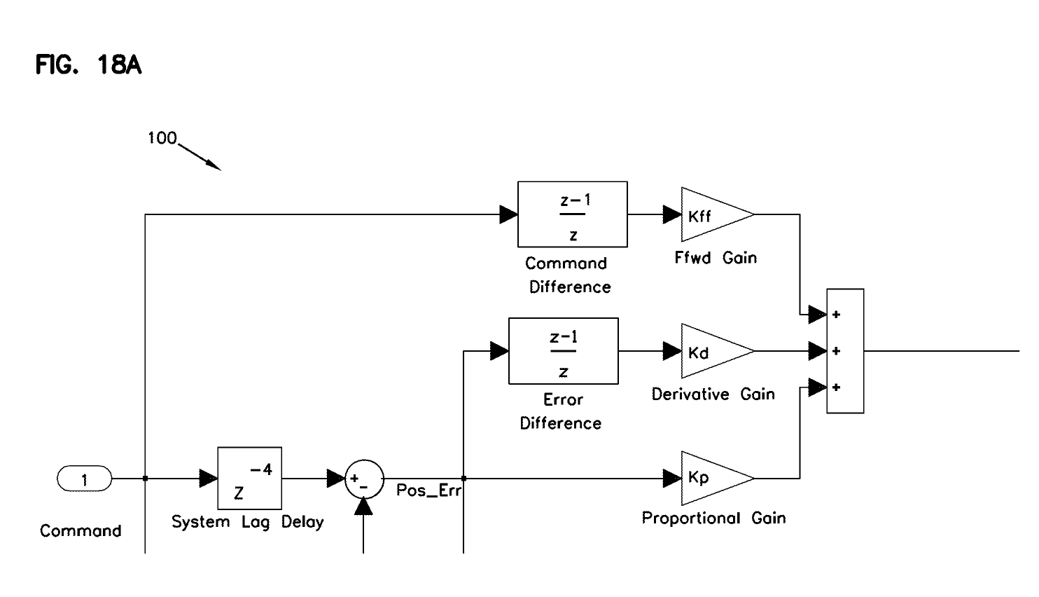

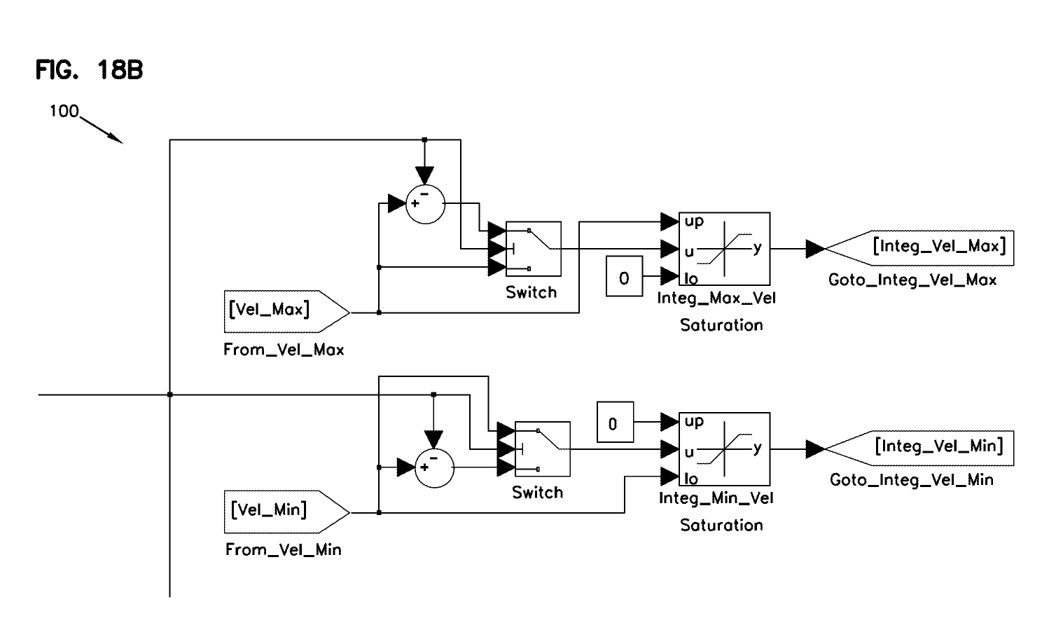

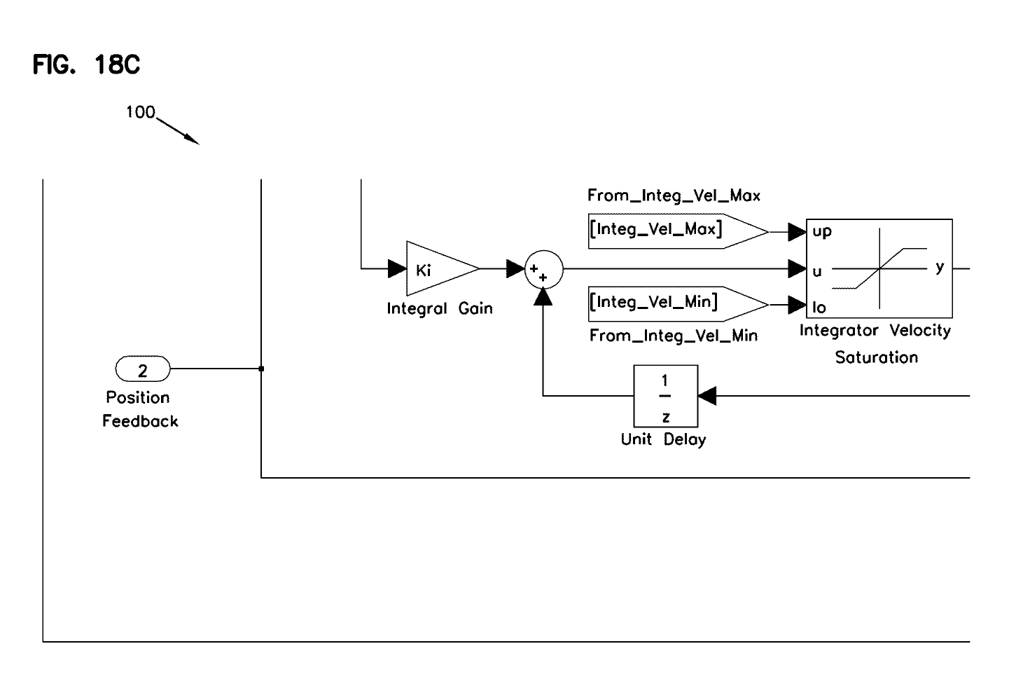

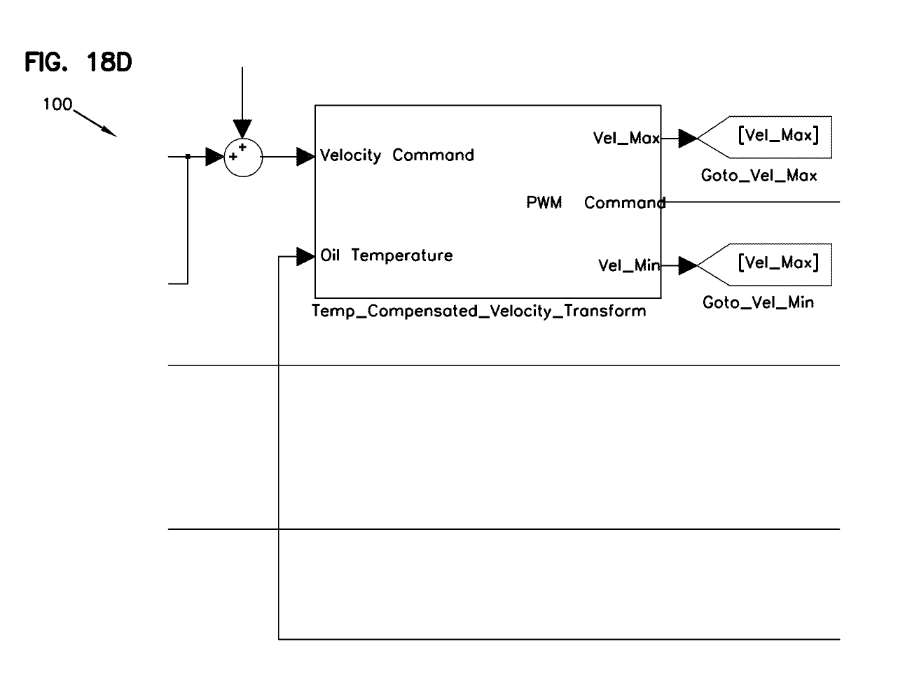

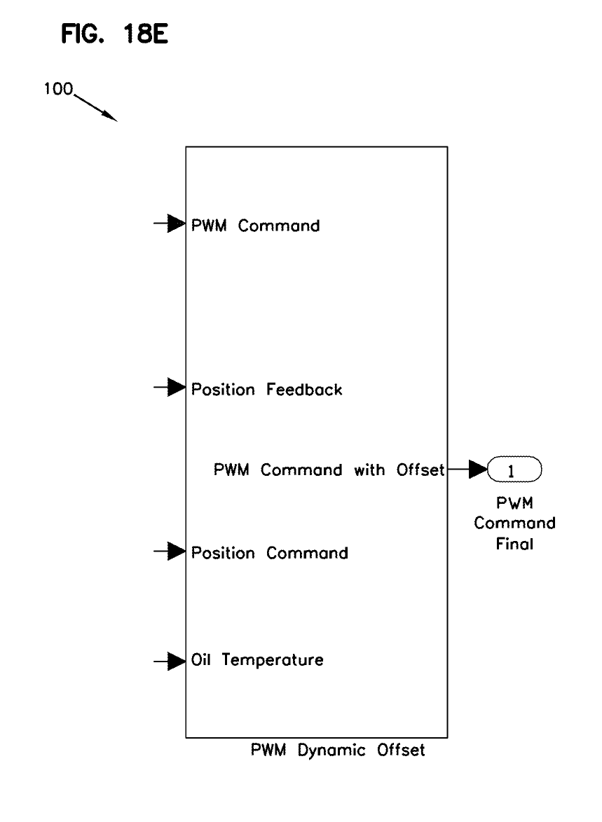

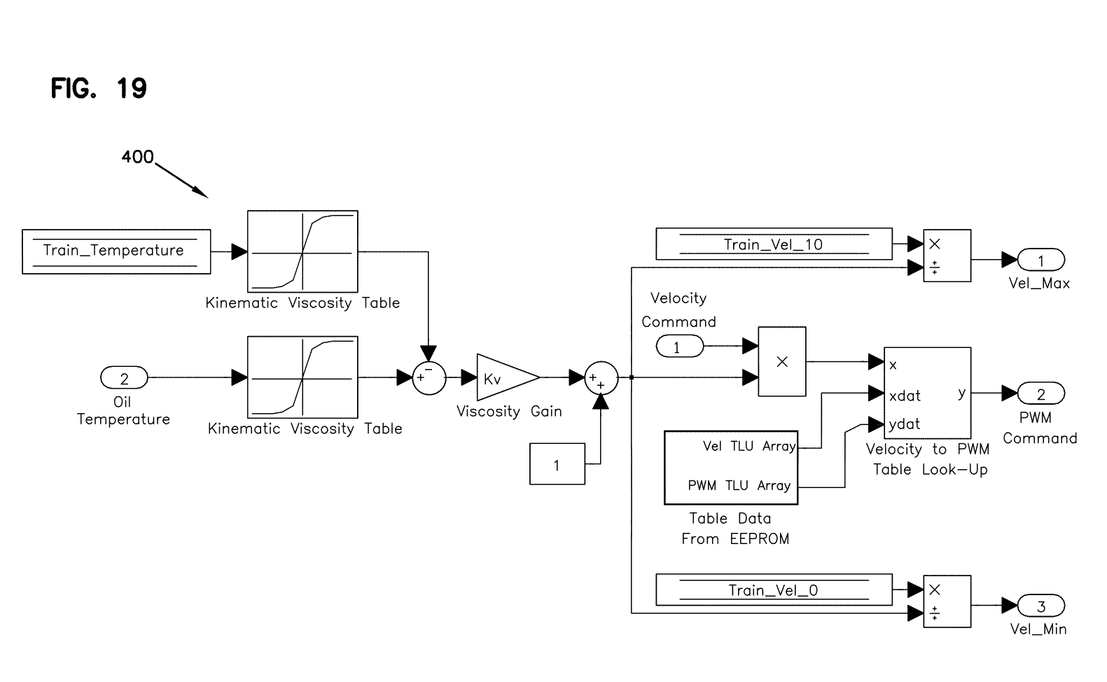

The position control module 300 process steps are shown in FIG. 14 while an exemplary schematic of the controller is shown in FIG. 18. In a first step of the process 302, the position control module 300 receives a position command from the microprocessor 100. As stated earlier, the position command can come from an operator, such as through a user operated joystick. In a second step 304, the control loop is delayed by a sample delay increment. In one embodiment, the sample delay increment is set to at least four samples long, for example z⁻⁴, although any sample length can be utilized. The sample delay increment allows for the time lag between the position command being sent and the point at which the valve spool 20 actually starts moving, and prevents the integral portion of the controller from winding up unnecessarily. This delay in movement is affected by temperature, valve construction, and inherent delays in generating a signal from the controller to the main spool. Accordingly, the delay is valve and condition specific. In one embodiment, the position control module 300 can set the sample delay increment by using the operating fluid temperature or viscosity as an input via modeling or values from empirical testing. The sample delay also allows for the feed forward part of the control loop to operate initially before calculating the position error difference in step 308, described below.

After the sample delay step 304, the position error difference is calculated at step 308 between the position feedback input 106 received at step 306 and the delayed position command. The position error difference is then multiplied by a proportional gain in step 310 to obtain a first velocity output. The position error difference is also used to calculate an error difference in a transform function, for example (1−z⁻¹), in a step 312, and then multiplied by a derivative gain in step 314 to obtain a second velocity output. In a step 316, a position command difference, for example (1−z⁻¹) , is calculated in a transform function without the sample delay from step 304. This result is then multiplied by a feed forward gain in a step 320 to obtain a third velocity output. Step 320 may also include receiving a velocity command 302a. The velocity command 302a can come from a first difference (1−z⁻¹) calculation on the position command or from another source, such as a command generator when the position and velocity are in integral relation. It is also noted that the velocity command 302a could be received at derivative gain block 314 where velocity differences are used instead of position differences. In a step 322, the first, second, and third velocity outputs are summed together.

In an integration loop, the position error difference is multiplied by an integral gain in a step 324 which is then limited in step 326. In step 326, the valve minimum and maximum velocities acquired during training (Vel_Min 114 and Vel_Max 116) limit the integration speed as does the difference between the summed result from step 322 and these velocity values. It is noted that the training velocities utilized can be temperature compensated in the velocity transform module 400 to account for changes in fluid viscosity, as explained further later. By limiting the integration in this manner, the integral gain can be set significantly higher without causing unnecessary overshooting while preventing the controller from outputting a velocity that is beyond the capabilities of the valve spool 20.

The output of the integration loop is a fourth velocity output, as calculated in step 326. In a step 328, the fourth velocity output is summed with the result of step 322 to output a velocity command 110. The velocity command 110 can then be received by the velocity transform module 400.

The velocity transform module 400 is for scaling the velocity command 110 to account for any changes in viscosity due to temperature differences between the fluid during training and the fluid during actual operation. This compensation allows for the module 400 to output a temperature compensated initial PWM command 112. By utilizing the velocity transform function in combination with the temperature compensated training data, the system has a more linear response. Velocity transform module 400 also temperature compensates for the minimum and maximum spool valve velocities attained during the training process.

In a first step 402 of the temperature compensation process, the current operating fluid temperature is received. Subsequently, in step 404, the corresponding fluid viscosity is obtained from a viscosity lookup table stored in the controller 100. The lookup table may include kinematic and/or dynamic viscosity values. In a step 406, the training fluid temperature is received and the corresponding training fluid viscosity is obtained from the viscosity table in a step 408. Instead of a single viscosity table, independent tables containing data for the same or different fluids can be utilized, if desired. In a step 410, the training fluid viscosity is subtracted from the operating fluid viscosity resulting in a viscosity difference.

In a step 412, the viscosity difference is multiplied by a viscosity gain and added to the number 1 such that a per unit scaling value is obtained. The velocity command is received at step 414 and then multiplied by the scaling value at step 416. In a step 418, the initial PWM command is determined from the scaled velocity command and training data lookup table stored on the controller that correlates PWM output (PWM_TLU_Array) and spool velocity (VEL_TLU_Array) as control parameters. The control parameters may be stored and utilized in multiple ways, for example: a single lookup table at a single training temperature; multiple table lookups at multiple training temperatures and/or multiple fluid types; and polynomial calculations based on viscosity changes. Where the training fluid is a different type than the operating fluid, a fluid type input can be provided to the controller by a user such that the internal temperature utilized by the controller can be offset to an appropriate degree. In many applications, such an approach is possible because the fluids used in this type of valve system generally have similar viscosity characteristic profiles with respect to changes in temperature.

In steps 420 and 422, the viscosity corrected spool maximum velocity and the minimum velocity are calculated by dividing the maximum and minimum spool velocities (e.g. train_vel_10, train_vel_0 in FIG. 21), recorded during training, by the scaling value from step 412. As stated previously, these corrected velocities can be utilized in the position control module 300 to limit the control loop integration.

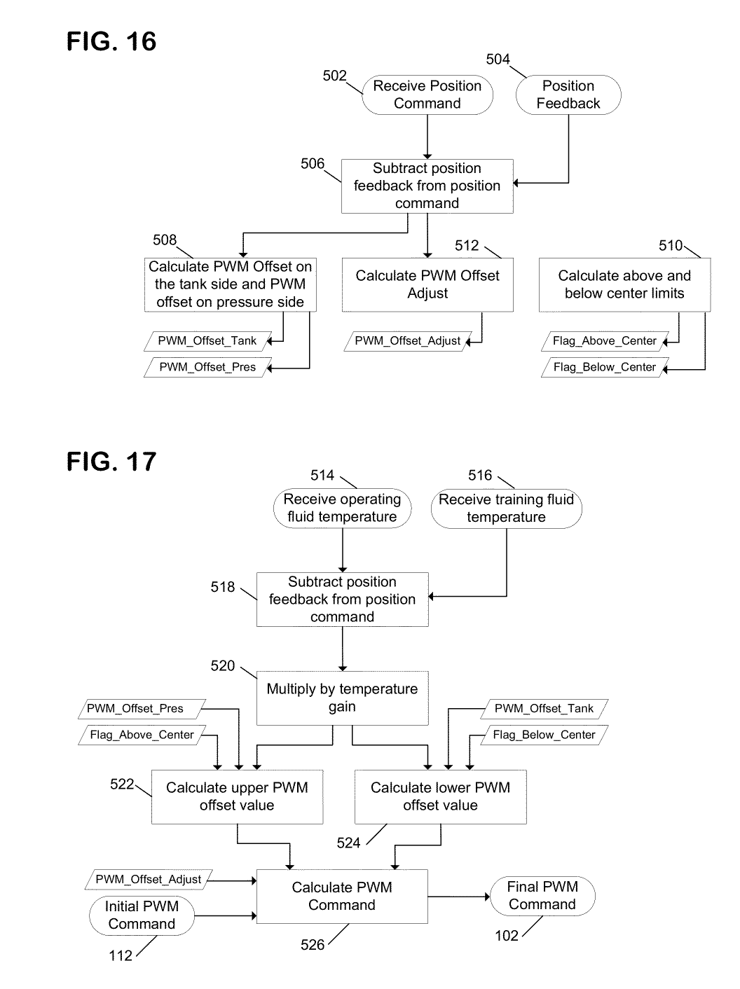

Referring to FIGS. 16 and 17, the process relating to the dynamic offset module 500 is shown. The dynamic offset module 500 modifies and applies the PWM offset values determined during the training process to the initial Final PWM command 102 such that entire offset is not utilized under certain conditions. For example, when the valve spool 20 is tracking very close to the commanded position, the offset value can be adjusted by the dynamic offset module 500 to prevent the valve from overshooting or hunting. Such an approach allows for the offset to be linearly applied based on the actual spool position in relationship to the commanded position and in relationship to the null position.

In steps 502 and 504, the position command signal and the position feedback signal are received, respectively. In a subsequent step 506, an error difference is calculated by subtracting the position feedback signal from the position command signal. In a step 508, the error difference is relied upon to modify the training PWM offsets on the tank and pressure sides, which are then outputted, for example, as PWM_Offset_Tank and PWM_Offset_Pressure, respectively. In a step 512, the error difference is relied upon to calculate a modified PWM offset adjustment value and outputted as, for example, PWM_Offset_Adjust. In a step 510, above and below center spool position limits are calculated to define the boundaries of the desired dead zone in which the PWM offset value will be applied, for example Flag_Above_Center and Flag_Below_Center.

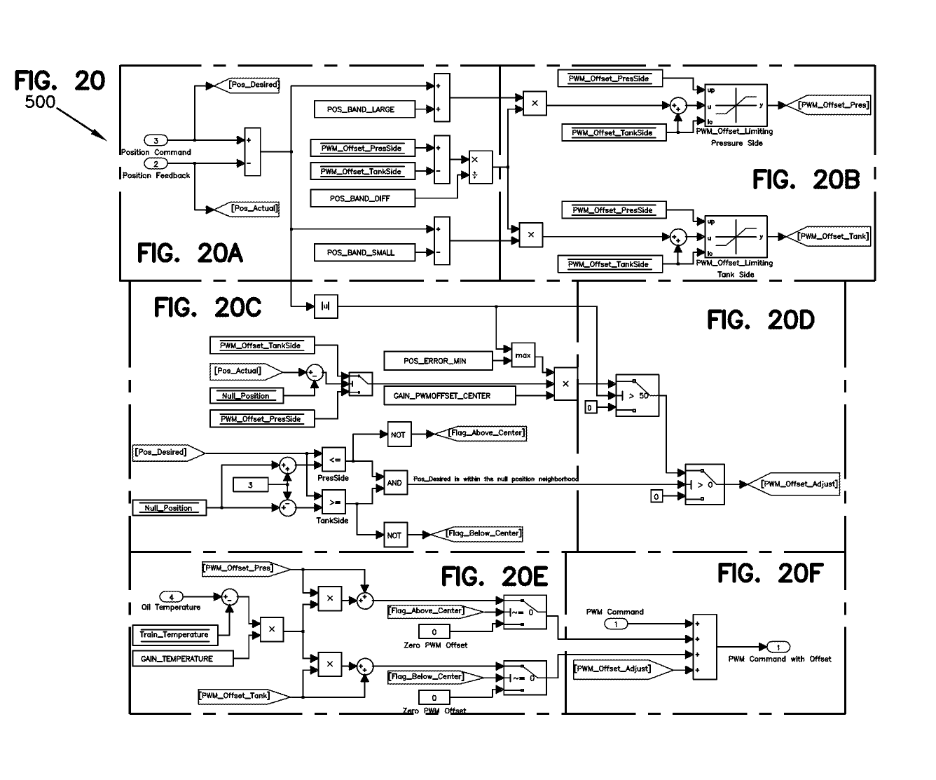

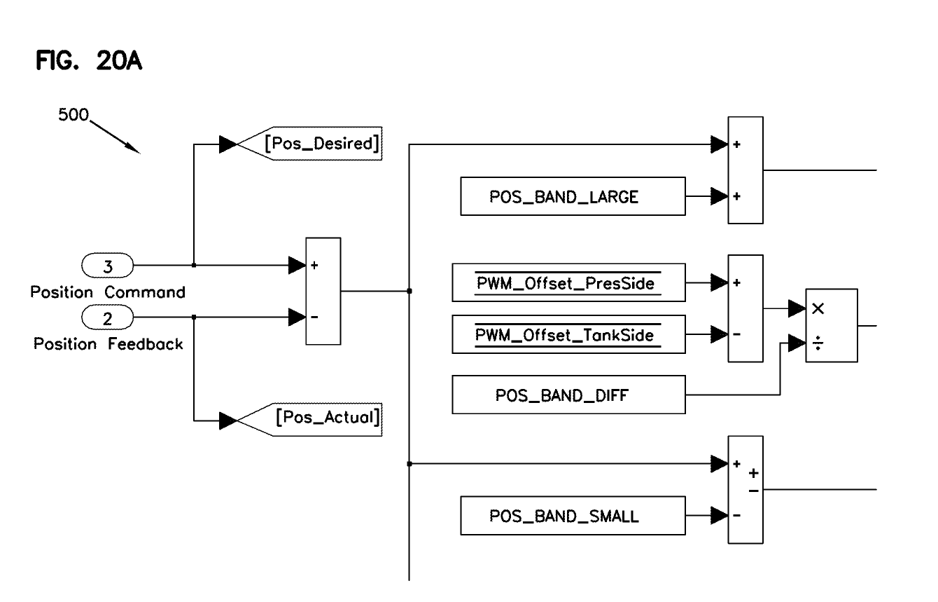

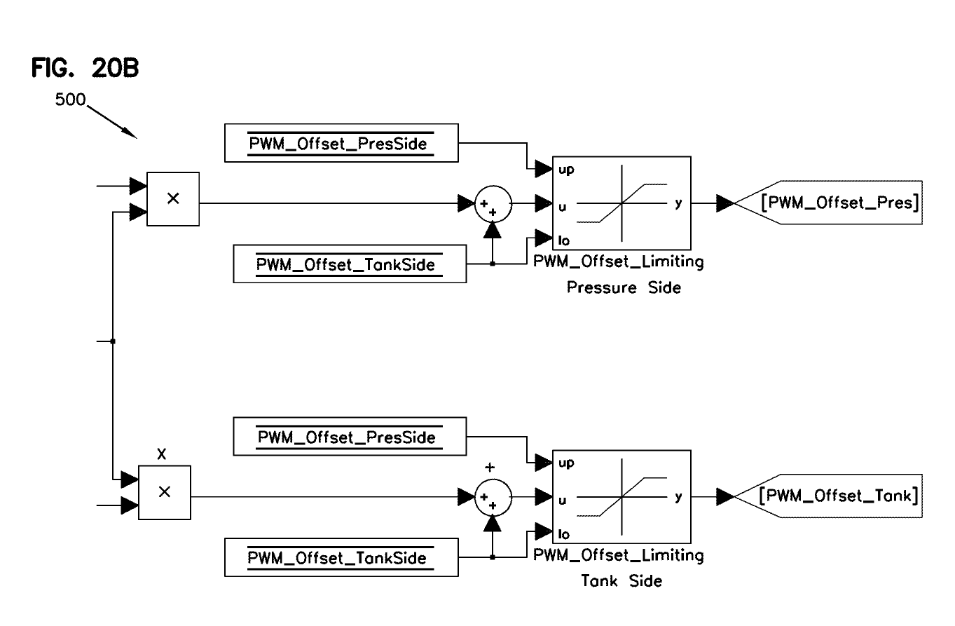

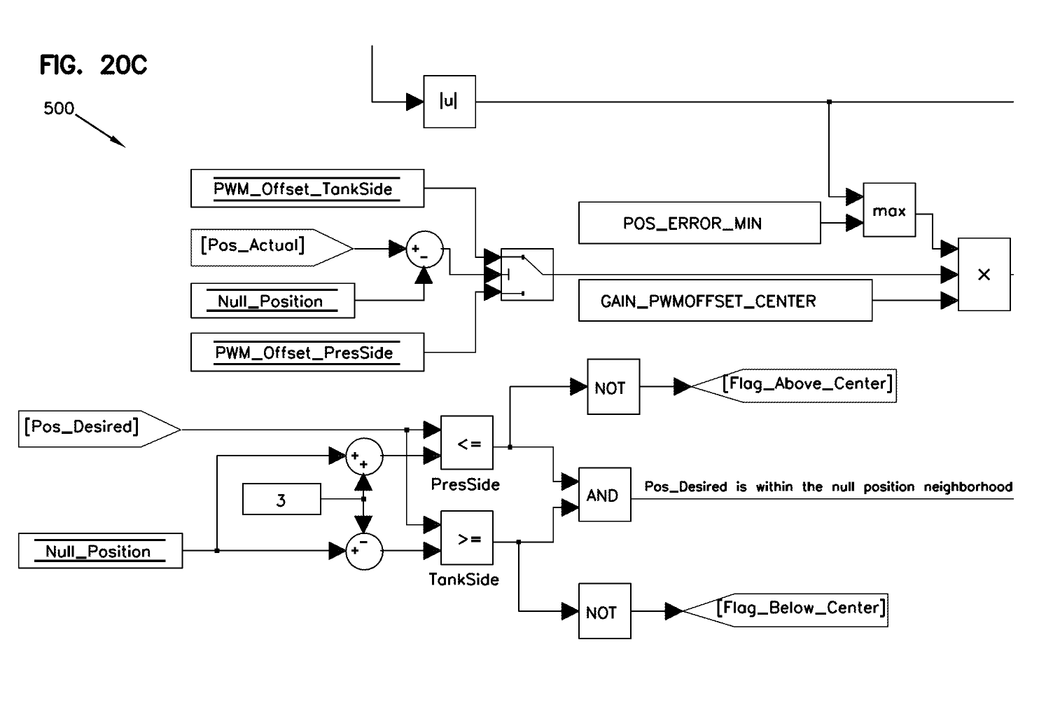

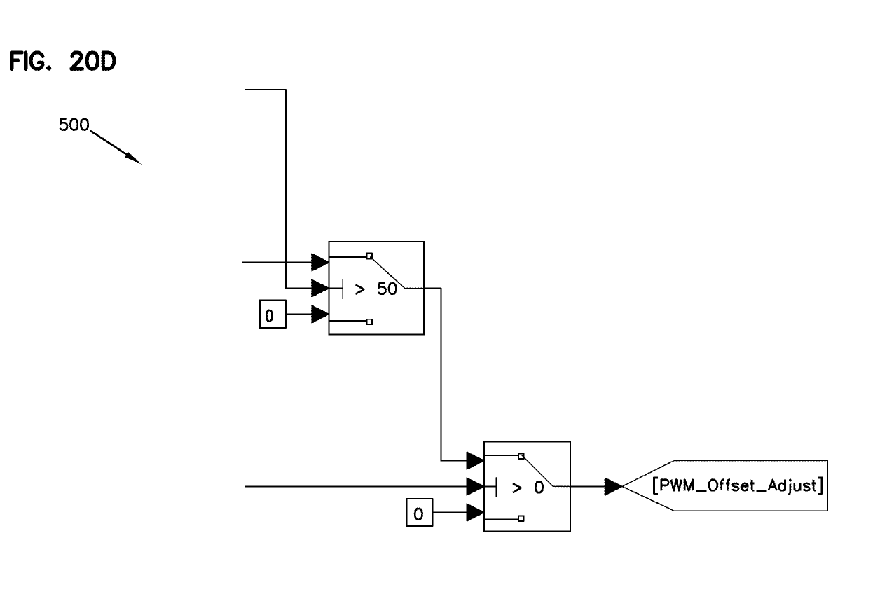

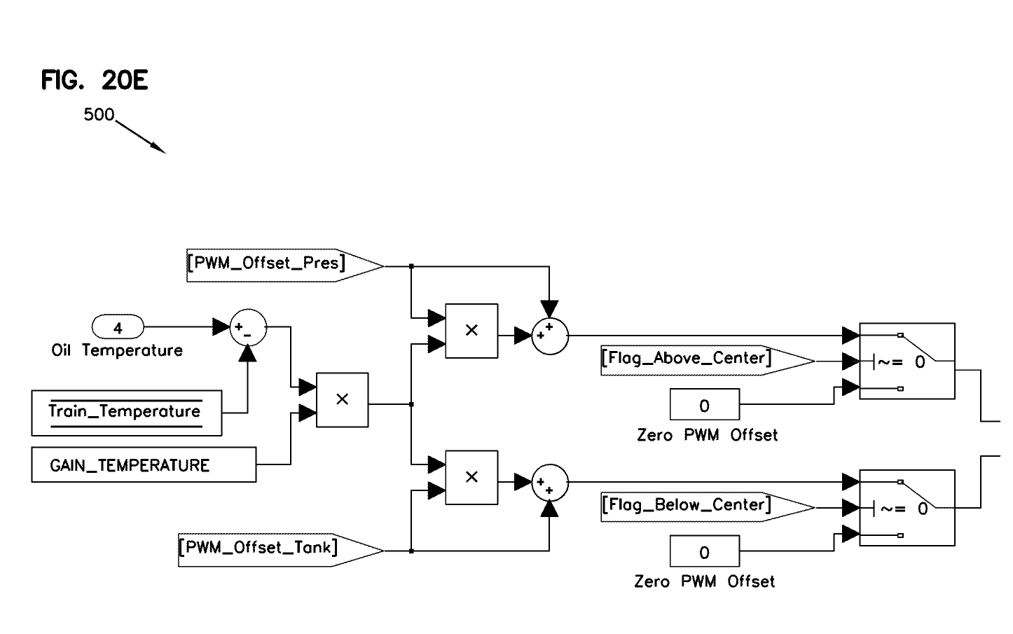

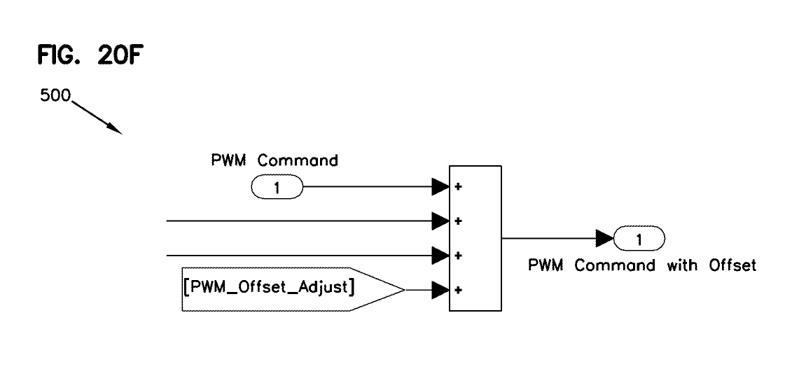

Referring to FIG. 17, the dynamic offset module 500 operation continues with receiving the operating fluid temperature at step 514 and the training fluid temperature at step 516. Alternatively, direct viscosity values could be received at this step. In a subsequent step 518, the training temperature is subtracted from the operating temperature and then multiplied by a temperature gain in step 520. The result is then used, in conjunction with the PWM_Offset_Pressure and Flag_Above_Center values, to calculate an upper PWM offset value in a step 522. The result is also used, in conjunction with the PWM_Offset_Tank and Flag_Below_Center values, to calculate a lower PWM offset value in a step 524. Once these calculations are performed, the outputs of steps 512, 522, 524, and the initial PWM command 112, can then be summed in step 526 to obtain the final PWM command 102 which is then sent to the valve actuator 24 by the controller 100. It is noted that a schematic example of the dynamic offset module 500 can be found in FIG. 20.

Taken together, the operation of the position controller module 300, the velocity transform module 400, and the dynamic offset module 500, in conjunction with the data obtained through the training protocol 200b, provide for a temperature compensated PWM output signal that gives the control valve assembly 16 a greater linear response profile than is typically associated with similar control valve configurations.

The example embodiments described herein can be implemented as logical operations in a computing device in a networked computing system environment. The logical operations can be implemented as: (i) a sequence of computer implemented instructions, steps, or program modules running on a computing device; and (ii) interconnected logic or hardware modules running within a computing device.

In general, the logical operations can be implemented as algorithms in software, firmware, analog/digital circuitry, and/or any combination thereof, without deviating from the scope of the present disclosure. The software, firmware, or similar sequence of computer instructions can be encoded and stored upon a computer readable storage medium and can also be encoded within a carrier-wave signal for transmission between computing devices. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for operating a valve control assembly having at least one main stage spool actuated by hydraulic fluid from a pilot stage spool, wherein the pilot stage spool is actuated by an output command from a controller, the method including the steps of:
a. training the valve control assembly with hydraulic fluid at a training temperature by correlating a plurality of output commands from the controller to a plurality of resulting main stage spool velocities;
b. receiving and transforming a main stage spool position command to a velocity command with a structured controller;
c. transforming the velocity command to an initial output command by accounting for a viscosity difference between hydraulic fluid at an operating temperature and the hydraulic fluid at the training temperature; and
d. transforming the initial output command to a final output command by adding a command offset value to the initial output command.

2. The method of training a valve control assembly according to claim 1, wherein the pilot stage spool is actuated by a coil.

3. The method for operating a valve control assembly according to claim 2, wherein the coil output command is a PWM output voltage to the coil.

4. The method for operating a valve control assembly according to claim 3, wherein the initial coil output command is an initial PWM output voltage and the final coil output command is a final PWM output voltage.

5. The method for operating a valve control assembly according to claim 4, wherein the step of training the valve control assembly further includes the steps of:
a. sensing the temperature of the hydraulic fluid;
b. correlating a plurality of pilot stage spool coil PWM output voltages to a plurality of resulting main stage spool velocities at the training temperature;
c. determining a minimum PWM output voltage to cause the main stage spool to start moving in at least one direction; and
d. storing the training temperature, the PWM output voltage, and the correlated velocity values as control parameters in the controller;

6. The method for operating a valve control assembly according to claim 1, further including the step of measuring the operating hydraulic fluid temperature.

7. The method for operating a valve control assembly according to claim 3, further including the step of sending the final coil output command to the pilot stage spool coil.

8. The method for operating a valve control assembly according to claim 6, wherein the step of transforming the velocity command to an initial coil output command includes:
a. determining a viscosity difference between the hydraulic fluid at the training temperature and the hydraulic fluid at the operating temperature;
b. temperature compensating the velocity command to account for the viscosity difference; and
c. referencing the control parameters to determine the initial PWM output voltage.

9. The method for operating a valve control assembly according to claim 5, wherein the step of transforming the initial coil output command to a final coil output command by adding a command offset value to the initial coil output command includes the command offset value being dependent upon at least some of the control parameters.

10. A method for operating a valve control assembly having at least one main stage spool actuated by hydraulic fluid from a pilot stage spool, wherein the pilot stage spool is actuated by a coil receiving a command PWM output voltage from a controller, the method including the steps of:
a. training the valve control assembly, including the steps of:
i. sensing a training temperature of the hydraulic fluid;
ii. correlating a plurality of pilot stage spool coil PWM output voltages to a plurality of resulting main stage spool velocities at the training temperature;
iii. determining a minimum PWM output voltage to cause the main stage spool to start moving in at least one direction;
iv. storing the training temperature, the PWM output voltage, and the correlated velocity values as control parameters in the controller;
b. receiving and transforming a main stage spool position command to a velocity command with a structured controller;
c. measuring an operating hydraulic fluid temperature;
d. transforming the velocity command to an initial PWM output voltage, including the steps of:
i. determining a viscosity difference between the hydraulic fluid at the training temperature and the hydraulic fluid at the operating temperature;
ii. temperature compensating the velocity command to account for the viscosity difference;
iii. referencing the control parameters to determine the initial PWM output voltage;
e. transforming the initial PWM output voltage to a final command PWM output voltage by adding a PWM voltage offset value to the initial PWM output, the offset value being dependent upon at least some of the control parameters; and
f. sending the final command PWM output voltage to the pilot stage spool coil.

11. A method of training a valve control assembly having at least one main stage spool actuated by hydraulic fluid from a pilot stage spool, wherein the pilot stage spool is actuated by an output command from a controller, the method including the steps of:
a. sensing and recording a training fluid temperature;
b. setting a maximum loop index value;
c. initializing a loop index to an initial value;
d. outputting a predetermined output command to the pilot stage spool;
e. calculating the characteristic velocity of the main stage spool;
f. storing the characteristic spool velocity corresponding to the output command from the controller;
g. returning the main stage spool to a null position;
h. incrementing the loop index; and
i. repeating steps d-h until loop index is equal to the maximum loop index value.

12. The method of training a valve control assembly according to claim 11, wherein the pilot stage spool is actuated by a coil.

13. The method of training a valve control assembly according to claim 12, wherein the output command from the controller is a PWM output voltage.

14. The method of training a valve control assembly according to claim 13, wherein the step of outputting a predetermined output command to the pilot stage spool includes outputting a predetermined output PWM voltage to the coil.

15. A method of training a valve control assembly having at least one main stage spool actuated by hydraulic fluid from a pilot stage spool, wherein the pilot stage spool is actuated by a coil receiving a command PWM output voltage from a controller, the method including the steps of:
a. sensing and recording a training fluid temperature;
b. setting a maximum loop index value;
c. initializing a loop index to an initial value;
d. outputting a predetermined output PWM voltage to the pilot stage spool coil;
e. calculating the characteristic velocity of the main stage spool;
f. storing the characteristic spool velocity corresponding to the output PWM voltage;
g. returning the main stage spool to a null position;
h. incrementing the loop index; and
i. repeating steps d-h until loop index is equal to the maximum loop index value.
